(19) United States
(12) Patent Application Publication
(10) Pub. No.: US 2017/0253701 A1
(43) Pub. Date: Sep. 7, 2017

(54) Comb-Star Viscosity Modifier and Its Compositions

(71) Applicant: EXXONMOBIL CHEMICAL PATENTS INC., Baytown, TX (US)

(72) Inventors: Andy H. Tsou, Houston, TX (US); Donna J. Crowther, Seabrook, TX (US); Man Kit Ng, Basking Ridge, NJ (US); Tabassumul Haque, Deptford, NJ (US); Hong Cheng, Bridgewater, NJ (US); Patrick Brant, Seabrook, TX (US); Martin N. Webster, Pennington, NJ (US); Yong Yang, Kingwood, TX (US); Liehpao O. Farng, Lawrenceville, NJ (US); Rahul R. Kulkarni, Pune (IN)

(73) Assignee: Exxonmobile Chemical Patents Inc., Baytown, TX (US)

(21) Appl. No.: 14/898,908

(22) PCT Filed: Jun. 30, 2014
(86) PCT No.: PCT/US2014/044834

§ 371 Date: Dec. 16, 2015

Related U.S. Application Data
(60) Provisional application No. 61/860,407, filed on Jul. 31, 2013.

(51) Int. Cl. C08G 77/442

(52) U.S. Cl. CPC C08G 77/442

(57) ABSTRACT

Described herein is a comb-star poly(siloxane-polyolefin) comprising the reaction product of at least vinyl-terminated macromer and functional-poly(dialkylsiloxanes) comprising 2 or more functional groups, wherein the comb-star poly(siloxane-polyolefin) has the following features: a g′_{(vis avg)} of less than 0.80; a comb number of 2 or 3 or 4 to 30 or 40 or 50 or 100 or more; and a number average molecular weight (Mn) within the range of from 25,000 g/mole to 500,000 g/mole.

### PRIORITY CLAIM TO RELATED APPLICATIONS

This present application claims priority to U.S. Ser. No. 61/860,407, filed on Jul. 31, 2013, which is herein incorporated by reference.

### FIELD OF THE INVENTION

The present inventions relate to very highly branched polymer compositions, “comb-star” polymers, useful as viscosity modifiers, wherein the polymer backbone is a low molecular weight poly siloxane and the “combs” are derived from vinyl-terminated macromers.

### BACKGROUND

Early in the lubricant's industry, the viscosity index (VI), which is related to the “inverted” temperature coefficient of viscosity with a larger VI value corresponding to a smaller change in viscosity with temperature, has been used as a measure of lubricant quality. Starting in the 1950's till 1990's, five types of polymers have emerged as the preferred VIIs (viscosity index improvers) or VMs (viscosity modifiers). They are also called VMs since, beyond their ability in raising the VI of the lubricant basestock, they can deliver shear thinning at high shear rates for improved fuel economy.

A VM is preferred to have strong thickening power (a large increase in viscosity with a small addition, related to the VM coil size in a base stock), shear stability, thermo-oxidative stability, good low temperature viscometric, early onset of shear thinning, and positive temperature coefficient (thickening power increases with increasing temperature). The reason that there are five types of VMs being used presently is largely because none of them can deliver all the required thickening efficiency, stability, low temperature property, shear thinning, and temperature coefficient. The five types of polymers presently being used in commercial lubricants as VMs are OCPs (olefin copolymers), SIPs (hydrogenated styrene-isoprene copolymers), PMAs (polymethacrylates), SPE (esterified poly(styrene-co-maleic anhydride), and PMA/OCP compatibilized blends (see P. M. Mortier and S. T. Orszulik, “Chemistry and Technology of Lubricants”, 2^{nd} Ed., Blackie Academic, New York, Chapter 5). The most commonly used VMs are OCPs, SIPs, and PMAs. These, however, have drawbacks and could be improved upon.

The synthesis of highly branched materials that could be used as viscosity modifiers has been achieved, according to the present invention, in one way by hydrosilation chemistry of vinyl terminated macromers. Polyhydromethylsiloxane (PHMS) is an inexpensive and commercially available material with active Si—H bonds and is available in various chain lengths or Mn's. The Si—H bond has been found to react with lower molecular weight vinyl terminated macromers (“VTMs”), the synthesis of VTM's as described in US 2012-0245311, U.S. Pat. No. 8,318,998, and US 2013-0023633. Modification of the reaction conditions now allow for the hydrosilation of higher molecular weight vinyl terminated macromers with high conversions as described herein.

Other references of interest include PCT/US2013/060583; WO 97/06201, WO 2009/155472, US 2009-0318640, US 2012-0245300, US 2012-0245293, U.S. Pat. No. 6,117,962, U.S. Pat. No. 8,168,724, U.S. Pat. No. 8,283,419; 114 J. Appl. Poly. Sci. pp. 892-900 (2009); 27 Macromolecules p. 3310 (1994); and 104 J. Appl. Poly. Sci. p. 1176 (2007).

### SUMMARY

The invention herein includes a comb-star poly(siloxane-polyolefin) comprising the reaction product of at least vinyl-terminated macromer and functional-poly(dialkylsiloxanes) comprising 2 or more functional groups, wherein the comb-star poly(siloxane-polyolefin) has the following features: a g′_{(vis avg)} of less than 0.80 or 0.70 or 0.60 or 0.50; a comb number of 2 or 3 or 4 to 30 or 40 or 50 or 100 or more; and a number average molecular weight (Mn) within the range of from 25,000 or 50,000 or 75,000 or 100,000 g/mole to 300,000 or 350,000 or 400,000 or 500,000 g/mole.

The invention can also be described as a comb-star poly(siloxane-polyolefin) (or “comb-star polymer”), wherein the poly(siloxane-polyolefin) is a mixture of polymers having the general structure:

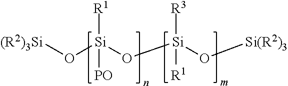

wherein “PO” is the vinyl-terminated macromer portion of the reaction product; each R¹, R² and R³ is independently selected from C₁ to C₁₀ or C₂₀ alkyls; and n (the “comb number”) and m are integers from 3 or 5 to 50 or 80 or 100 or 200.

The comb-star poly(siloxane-polyolefin) is useful as a viscosity modifier (VM) in base stock compositions used as a lubricant.

### BRIEF DESCRIPTION OF THE DRAWING

FIG. 1 is the ¹H NMR study of the reaction product in Example 1.

FIG. 2 is the ¹H NMR study of the reaction product in Example 2.

FIGS. 3A and 3B are graphical representations of Intrinsic Viscosity versus molecular weight from GPC-3D of Example 3.

FIG. 4 is a graphical representation of Intrinsic Viscosity and viscometric radius of SV300 comb-star as a function of temperature.

FIG. 5 is a graphical representation of Hydrodynamic radius of the comb-star polymer of Example 3 as a function of temperature.

### DETAILED DESCRIPTION

This invention relates to comb-star polymers and their synthesis, where the combs are amorphous polyolefins and the backbone is a hydrocarbon-solvent-insoluble and geminal-substituted polysiloxane. When this comb-star polymer is dissolved into a hydrocarbon base stock as a viscosity modifier in lubricant applications, the insoluble backbone coil collapses while the soluble polyolefin combs become star arms. The star conformation of the said comb-star copolymer viscosity modifier provides the thickening efficiency while delivering shear thinning. The geminal substitution on the backbone of this copolymer ensures the coil expansion with temperature for improved viscosity index. This collapsed backbone is stretched out under high extensional and shear flows thus enhancing the stability preventing the chain breakage during flow. Most specifically, this invention is related to the synthesis of comb-star copolymers by reactive coupling of vinyl or vinylidene terminated amorphous polyolefin comb arms to the hydrocarbon-solvent-insoluble polymer backbone.

The “comb number”, or number of polyolefin branches on the backbone poly(dialkyl siloxane), is preferably within ranges of from 2 to 100, more preferred from 3 to 50, and most preferred from 4 to 30, as well as others described herein. The comb molecular weight is preferably within the range from 1,000 to 250,000 g/mol, more preferred from 5,000 to 150,000 g/mol, and most preferred from 7,500 to 100,000 g/mol, as well as others described herein. The polyolefin comb is preferred to be an atactic propylene homopolymer or a propylene-alpha olefin copolymer or an ethylene-alpha olefin copolymer having crystallinity less than 10%, most preferred to be less than 5%. The polymer backbone is preferred to be hydrocarbon-solvent-insoluble and geminal-substituted polymers, such as poly(dialkyl siloxane), poly(alkyl methacrylate), and poly(vinylidene fluoride). The number average molecular weight (Mn) of the polymer backbone is preferred to be from 500 to 50,000 g/mol, more preferred from 750 to 25,000 g/mol, and most preferred from 1,000 to 10,000 g/mol, as well as others described herein. One method to prepare this comb-star copolymer is by hydrosilylation of vinyl terminated atactic polypropylene combs to poly(methylhydrosiloxane) (PMHS) backbone followed by capping all unreacted backbone hydrosilanes with an alkene such as octene, especially C₂ to C₁₀ or C₁₆ α-olefins.

The inventors have found that efficient functionalization of polysiloxane backbone with vinyl-terminated (or vinylidene-terminated) macromers can be achieved a number of ways. One way is via the thiol-ene addition of thiol group (SH, also known as mercaptan) across the vinyl group. Examples of commercially available polysiloxane containing propyl mercaptan side chains are poly(3-mercaptopropyl methylsiloxane and (3-mercaptopropyl methylsiloxane)-dimethylsiloxane copolymer (available from Gelest). Another is through reaction of the vinyl-terminated macromer with the hydride of the hydrosilane backbone itself. This is surprising, as some have found that not all Si—H bonds are reactive. See 114 J. Appl. Poly. Sci. 892-900 (2009); 27 Macromolecules 3310 (1994); and 104 J. Appl. Poly. Sci. 1176 (2007). In any case, upon functionalization of polysiloxane with polymeric alkyl groups, these organic-inorganic hybrid materials are rendered highly soluble in nonpolar medium such as polyalpholefin and mineral oil base stocks. These materials are suitable for uses as friction modifiers/traction reducers, and/or antiwear (AW) additives in lubricant formulations and in polymer applications.

The functional-poly(alkylsiloxane) polymer or copolymer containing different hydride, thiol groups or other functional groups are all commercially available materials. The exact content of the thiol or other functional group per gram of polymer can be determined by elemental analysis for carbon, hydrogen and sulfur. Although the solubility of these functional-poly(alkylsiloxane) starting materials in non-polar organic solvents such as aliphatic or aromatic hydrocarbons are generally poor, it has been discovered that the primary thiol group (—SH) can be made to undergo an addition reaction (commonly known as the thiol-ene reaction) across the terminal double bond of VTMs under extremely mild conditions. Typical reaction conditions are photochemically induced radical-based (at or below 2 mol % of photoinitiator used) at room temperature (20° C.) and without exclusion of oxygen (i.e., open air). The conversion of vinyl groups to the new thioether functionalities are very rapid, usually requiring only minutes to reach completion, as indicated by the rapid formation of a homogeneous solution upon UV light irradiation. The resulting oil-soluble polysiloxane derivatives containing VTM-based alkyl side groups can find applications as high shear-stable friction modifiers (FM) (or “traction reducers”, “viscosity modifiers”) in lubricant blends due to the large number of alkyl branches introduced to the polysiloxane backbone.

The vinyl-terminated macromers useful as the “comb” portion of the comb-star polymers described herein can be made in any number of ways. Preferably, the VTM's useful herein are polymers as first described in US 2009-0318644 having at least one terminus (CH₂CH—CH₂-oligomer or polymer) represented by formula (I):

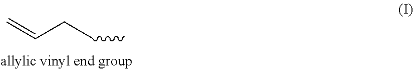

where the [symbol] represents the oligomer polymer chain.

In a preferred embodiment, the allyl chain ends are represented by the formula (II):

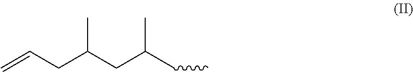

The amount of allyl chain ends is determined using ¹H NMR at 120° C. using deuterated tetrachloroethane as the solvent on a 500 MHz machine, and in selected cases confirmed by ¹³C NMR. These groups (I) and (II) will react to form a chemical bond with a metal as mentioned above to form the M-CH₂CH₂— polymer. In any case, Resconi has reported proton and carbon assignments (neat perdeuterated tetrachloroethane used for proton spectra while a 50:50 mixture of normal and perdeuterated tetrachloroethane was used for carbon spectra; all spectra were recorded at 100° C. on a Bruker AM 300 spectrometer operating at 300 MHz for proton and 75.43 MHz for carbon) for vinyl-terminated propylene polymers in Resconi et al, 114 J. AM. CHEM. Soc. 1025-1032 (1992) that are useful herein.

The vinyl-terminated propylene-based polymers may also contain an isobutyl chain end. “Isobutyl chain end” is defined to be an oligomer having at least one terminus represented by the formula (III):

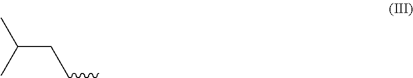

In a preferred embodiment, the isobutyl chain end is represented by one of the following formulae:

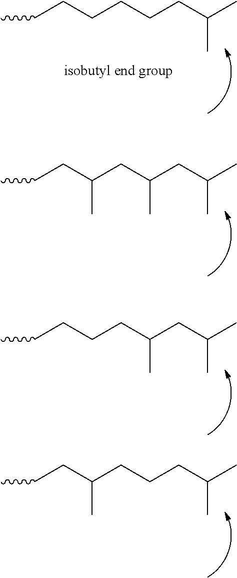

The percentage of isobutyl end groups is determined using ¹³C NMR (as described in the example section) and the chemical shift assignments in Resconi for 100% propylene oligomers. Preferably, the vinyl-terminated polymers described herein have an allylic terminus, and at the opposite end of the polymer an isobutyl terminus.

The vinyl-terminated macromer can be any polyolefin having a vinyl-terminal group, and is preferably selected from the group consisting of vinyl-terminated isotactic polypropylenes, atactic polypropylenes, syndiotactic polypropylenes, and propylene-ethylene copolymers (random, elastomeric, impact and/or block), and combinations thereof, each having a Mn of at least 300 g/mole. Preferably, greater than 90 or 94 or 96% of the vinyl-terminated polyolefin comprises terminal vinyl groups; or within the range of from 10 or 20 or 30% to 50 or 60 or 80 or 90 or 95 or 98 or 100%. As described above, the vinyl-terminated macromers have a Mn value of at least 300 or 400 or 1000 or 5000 or 20,000 g/mole, or within the range of from 300 or 400 or 500 g/mole to 20,000 or 30,000 or 40,000 or 50,000 or 100,000 or 200,000 or 300,000 g/mole. Preferably, the VTM useful herein is amorphous polypropylene, and desirably has a glass transition temperature (Tg) of less than 0° C., more preferably less than −10° C., and most preferably less than −20° C.; or within the range of from 0 or -5 or −10° C. to −30 or -40 or 50° C. The VTMs are preferably linear, meaning that there is no polymeric or oligomeric branching from the polymer backbone, or alternatively, having a branching index “g” (or g′_{(vis avg)}), as is known in the art, of at least 0.96 or 0.97 or 0.98, wherein the “branching index” is well known in the art and measurable by published means, and the value of such branching index referred to herein within 10 or 20% of the value as measured by any common method of measuring the branching index for polyolefins as is known in the art such as in U.S. Ser. No. 13/623,242, filed Sep. 20, 2012, but most preferably, as described herein in detail below.

The polysiloxanes that are useful herein as the backbone portion of the comb-star polymers are functional-poly(dialkylsiloxanes) having a number average molecular weight (Mn) within the range of from 500 or 700 or 1000 g/mole to 4000 or 4400 or 4600 or 5000 or 25,000 or 50,000 g/mole. Desirably, the functional-poly(dialkylsiloxane) can be described by the following formula (I):

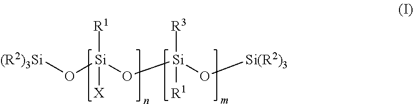

wherein n and m are integers from 2 or 3 or 5 to 50 or 80 or 100 or 200; each of R¹, R² and R³ are independently selected from C₁ to C₁₀ or C₂₀ alkyls, especially methyl, ethyl or propyl groups; and wherein X is a functional group capable of facilitating the formation of a bond between the vinyl group of the vinyl-terminated macromer and a silicon atom; and preferably, X is a hydride or a mercaptan such as methyl, ethyl, propyl or butyl mercaptans. By “facilitating the formation of a bond” what is meant is that the “X” group may be a leaving group that “activates” the silicon to which it is bound, which allows for the reaction of the vinyl group of the VTM with the silicon atom to which the “X” group is attached to form a silicon-carbon bond.

Thus, described herein is a comb-star poly(siloxane-polyolefin) comprising the reaction product of at least vinyl-terminated macromer and functional-poly(dialkylsiloxanes) comprising 2 or more functional groups (i.e., compounds of formula (I)), wherein the comb-star poly(siloxane-polyolefin) has the following features: a g′_{(vis avg)} of less than 0.80 or 0.70 or 0.60 or 0.50; a comb number of 2 or 3 or 4 to 30 or 40 or 50 or 100 or more; and a number average molecular weight (Mn) within the range of from 25,000 or 50,000 or 75,000 or 100,000 g/mole to 300,000 or 350,000 or 400,000 or 500,000 g/mole. Potentially, all of the functional groups of the functional-poly(dialkylsiloxanes) could react with the VTMs to form covalent bonds and displace the functional group. However, it is likely that only a portion of the functional groups on the polysiloxane chain will react. It is desirable that the final comb-star polymer not have residual functional groups, so the reaction above may additionally comprise combining a C₂ to C₁₀ or C₂₀ alkene, or more preferably an α-olefin such as a C₆ to C₁₂ α-olefin.

The combining or reacting of the functional-poly(dialkylsiloxanes) and VTM can take place in any desirable medium, but preferably in an aprotic medium, preferably in toluene, hexanes, benzene, or some other hydrocarbon and combination of such solvents. The temperature of the reaction can also be any desirable temperature, but is preferably between about 10 or 20° C. to 30 or 40 or 50° C. The reactants are preferably allowed to react for at least 1 or 2 or 5 or 10 or 20 hours, but less than 50 or 60 hours.

In this manner, residual functional groups on the polysiloxane backbone can be removed. Desirably, the residual functional groups on the silicon atoms, preferably silanes, is less than 1 mole %, preferably less than 0.5 mole %, most preferably less than 0.1 mole % relative to the original functional-poly(dialkylsiloxanes). This is typically accomplished after or during the reaction between the functional-poly(dialkylsiloxanes) and VTM with the α-olefin as described above, preferably a C₆ to C₁₂ α-olefin. Thus, all the silicon atoms are “geminally” substituted, meaning that there are either two alkyl groups bound to each silicon atom in the chain, or an alkyl and the VTM.

Further, the inventive comb-star poly(siloxane-polyolefin)s preferably have a weight average molecular weight (Mw) within the range from 1,000 or 5,000 or 7,500 or 10,000 or 100,000 or 200,000 g/mole to 100,000 or 150,000 or 250,000 or 300,000 or 400,000 or 500,000 g/mol, wherein the lower limit is less than the upper limit when combined. Desirably, the comb-star poly(siloxane-polyolefin)s have a weight average molecular weight (Mw) to number average molecular weight (Mn) ratio (Mw/Mn) within the range from 2.0 or 2.5 to 5.0 or 6.0. The comb-star poly(siloxane-polyolefin)s also preferably have a g′_{(z avg)} of less than 0.70 or 0.60 or 0.50 and are thus highly branched.

Described another way, the comb-star poly(siloxane-polyolefin) is a mixture of highly branched polymers having the general structure (II):

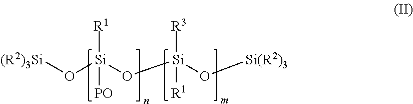

wherein “PO” is the vinyl-terminated macromer portion of the reaction product; each R¹, R² and R³ is independently selected from C₁ to C₁₀ or C₂₀ alkyls; and n (the “comb number”) and m are integers from 3 or 5 to 50 or 80 or 100 or 200. Desirably, the ratio of m/n is greater than 1 or 2 or 3 or 4; or preferably, wherein m/n is within a range of from 2 or 3 or 4 to 7 or 9 or 10 or 12.

As mentioned the inventive comb-star polymers described herein are particularly useful as viscosity modifiers in base stocks to make motor oils. Preferably, given the advantages of the inventive comb-star polymer, inventive base stocks consist essentially of, or consists of, the inventive comb-star polymer as the only VM component in the base stock. Thus, the invention here also includes a viscosity modified base stock comprising the poly(siloxane-polyolefin) of described herein and a lubricant base stock of Group I, Group II, Group III, Group IV, and Group V. Desirably, the comb-star poly(siloxane-polyolefin) is present in the base stock at a level within the range of from 0.05 or 0.10 or 0.40 wt % to 0.60 or 0.80 wt % or 1.0 or 5 wt % of the combination of base stock and poly(siloxane-polyolefin). These base stock-modifier compositions are improved over prior art compositions. For example, as the temperature of the inventive modified base stock increases, the hydrodynamic radius of the comb-star poly(siloxane-polyolefin) increases; wherein the radius increases by at least 2 or 4 or 6 or 8 nm for every 80 or 100° C. or more increase in temperature. This is highly desirable in modified base stock compositions.

The various descriptive elements and numerical ranges disclosed herein for the comb-star poly(siloxane-polyolefin)s, the reactants used to make the inventive polymer, and its use as a viscosity modifier, can be combined with other descriptive elements and numerical ranges to describe the invention(s); further, for a given element, any upper numerical limit can be combined with any lower numerical limit described herein. The features of the invention are described in the following non-limiting examples.

### Examples

Molecular weights of products were determined by GPC-MALLS/3D analysis or by GPC-DRI analysis with polystyrene standards. MH coefficients used were based on the polyolefin macromer or that employed in the hydrosilation reaction.

In particular, molecular weight and branching information were obtained by GPC-3D consisting of a Polymer Labs PL-GPC 220 system with three 300×7.5 mm PLgel 10 am MIXED-B LS columns and triple detectors (Wyatt Dawn HELEOS-II light scattering, differential viscometer, and differential refractive index detectors). The GPC solvent was TCB with 1500 ppm BHT and the operating temperature was 135° C. The branching index (g′) was determined from the GPC-3D data as the concentration-weighted average of [h]_{br}/[h]ₗᵢₙ, where [h]_{br} is the measured intrinsic viscosity of the branched polymer and [h]ₗᵢₙ is the predicted intrinsic viscosity of a linear polymer of the same molecular weight.

Mn, Mw, and Mz may be measured by using a Gel Permeation Chromatography (GPC) method using a High Temperature Size Exclusion Chromatograph (SEC, either from Waters Corporation or Polymer Laboratories), equipped with a differential refractive index detector (DRI). Molecular weight distribution (MWD) is Mw (GPC)/Mn (GPC). Experimental details, are described in: T. Sun, P. Brant, R. R. Chance, and W. W. Graessley, Macromolecules, Volume 34, Number 19, pp. 6812-6820, (2001) and references therein. Three Polymer Laboratories PLgel 10 mm Mixed-B columns are used. The nominal flow rate is 0.5 cm³/min and the nominal injection volume is 300 μL. The various transfer lines, columns and differential refractometer (the DRI detector) are contained in an oven maintained at 135° C. Solvent for the SEC experiment is prepared by dissolving 6 grams of butylated hydroxy toluene as an antioxidant in 4 liters of Aldrich reagent grade 1, 2, 4 trichlorobenzene (TCB). The TCB mixture is then filtered through a 0.7 m glass pre-filter and subsequently through a 0.1 μm Teflon filter. The TCB is then degassed with an online degasser before entering the SEC. Polymer solutions are prepared by placing dry polymer in a glass container, adding the desired amount of TCB, then heating the mixture at 160° C. with continuous agitation for about 2 hours. All quantities are measured gravimetrically. The TCB densities used to express the polymer concentration in mass/volume units are 1.463 g/mL at room temperature (20° C.) and 1.324 g/mL at 135° C. The injection concentration is from 1.0 to 2.0 mg/mL, with lower concentrations being used for higher molecular weight samples. Prior to running each sample the DRI detector and the injector are purged. Flow rate in the apparatus is then increased to 0.5 mL/minute, and the DRI is allowed to stabilize for 8 to 9 hours before injecting the first sample. The concentration, c, at each point in the chromatogram is calculated from the baseline-subtracted DRI signal, I_{DRI}, using the following equation:

c=K_{DRI}/I_{DRI}/(dn/dc)

where K_{DRI} is a constant determined by calibrating the DRI, and (dn/dc) is the refractive index increment for the system. The refractive index, n=1.500 for TCB at 135° C. and λ=690 nm. For purposes of this invention and the claims thereto, (dn/dc)=0.104 for propylene polymers and ethylene polymers, and 0.1 otherwise. Units of parameters used throughout this description of the SEC method are: concentration is expressed in g/cm³, molecular weight is expressed in g/mol, and intrinsic viscosity is expressed in dL/g.

The branching index (g′₍ᵥᵢₛ₎) is calculated using the output of the SEC-DRI-LS-VIS method as follows. The average intrinsic viscosity, [η]_{avg}, of the sample is calculated by:

$${[ η ]}_{avg} = \frac{\sum {{c}_{i} [ η ]}_{i}}{\sum {c}_{i}}$$

where the summations are over the chromatographic slices, i, between the integration limits.

The branching index g′₍ᵥᵢₛ₎ is defined as:

$${g}^{′} vis = \frac{{[ η ]}_{avg}}{{kM}_{v}^{α}}$$

where, for purpose of this invention and claims thereto, α=0.695 and k=0.000579 for linear ethylene polymers, α=0.705 and k=0.000262 for linear propylene polymers, and α=0.695 and k=0.000181 for linear butene polymers. My is the viscosity-average molecular weight based on molecular weights determined by LS analysis. See Macromolecules, 2001, 34, pp. 6812-6820 and Macromolecules, 2005, 38, pp. 7181-7183, for guidance on selecting a linear standard having similar molecular weight and comonomer content, and determining k coefficients and a exponents.

### Example 1

A Non-optimized example of functionalization of backbone pendant thiol-containing polysiloxane with VTM (atactic propylene homopolymer) was performed as follows:

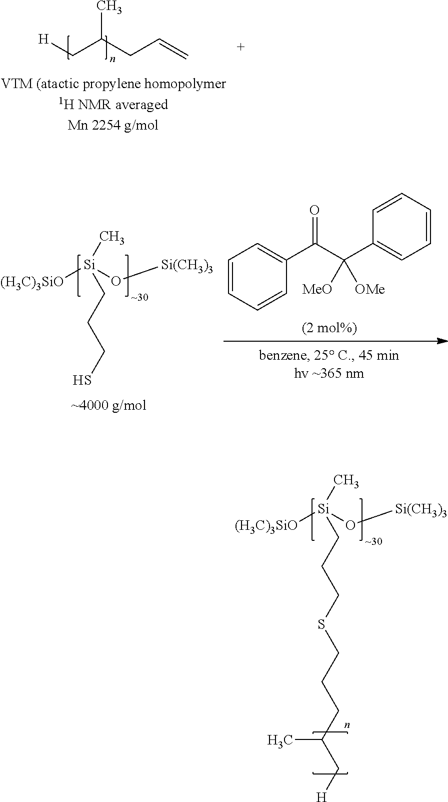

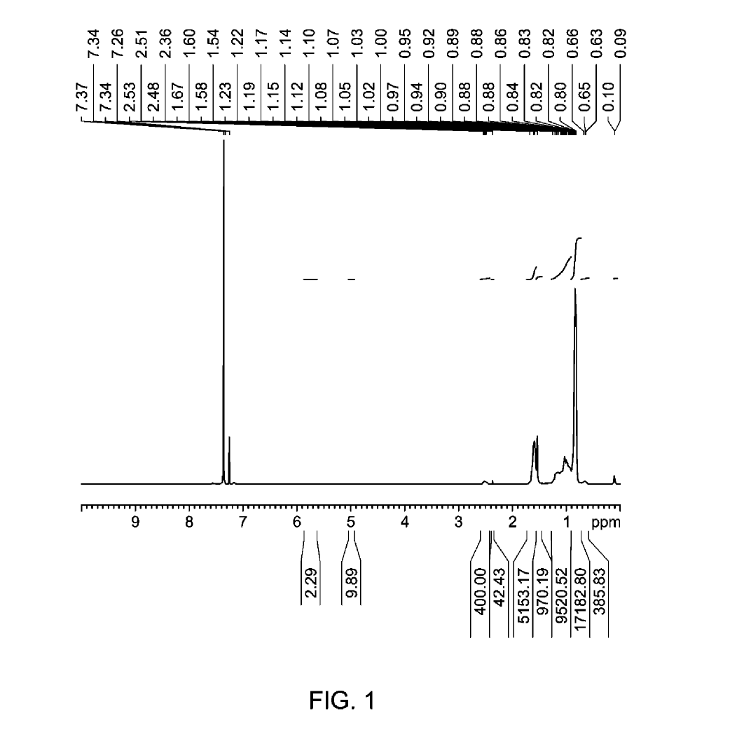

A mixture of vinyl-terminated atactic propylene homopolymer (¹H NMR Mn 2254.20 g/mol, 3.954 g, 1.7541 mmol), poly(3-mercaptopropyl methylsiloxane) (Mn of approximately 4000 g/mol, 0.250 g, 1.7542 mmol of thiol group/gram of polymer), 2,2-dimethoxy-2-phenylacetophenone (0.00899 g, 0.0351 mmol) and anhydrous benzene (2 ml) in a 20-ml vial was magnetically stirred at room temperature. The inhomogeneous mixture was irradiated with a 4 W UV lamp at 365 nm for 45 minutes at room temperature (20° C.). The mixture turned to a homogeneous solution after approximately 3 minutes of UV irradiation. After a reaction time of 45 minutes, an aliquot of the reaction mixture was analyzed by ¹H NMR (CDCl₃, 400 MHz), which showed the complete conversion of vinyl group to the corresponding thioether (polysiloxane-(CH₂)₃—S—(CH₂)₃—PP) functionality (δ 2.48-2.55 ppm, 4 Hs, CH₂—S—CH₂), in FIG. 1. The only impurities in the crude products are benzene (reaction solvent) and trace of toluene (from vinyl terminated “VT” aPP). The colorless solution was diluted with CH₂Cl₂ (10 ml), concentrated on a rotary evaporator, and dried under vacuum at 90° C. to give the highly branched aPP-functionalized polysiloxane material (4.12 g) as a colorless viscous oil.

### Example 2

A second non-optimized example of functionalization of backbone pendant thiol-containing polysiloxane with VTM (atactic propylene homopolymer) was performed:

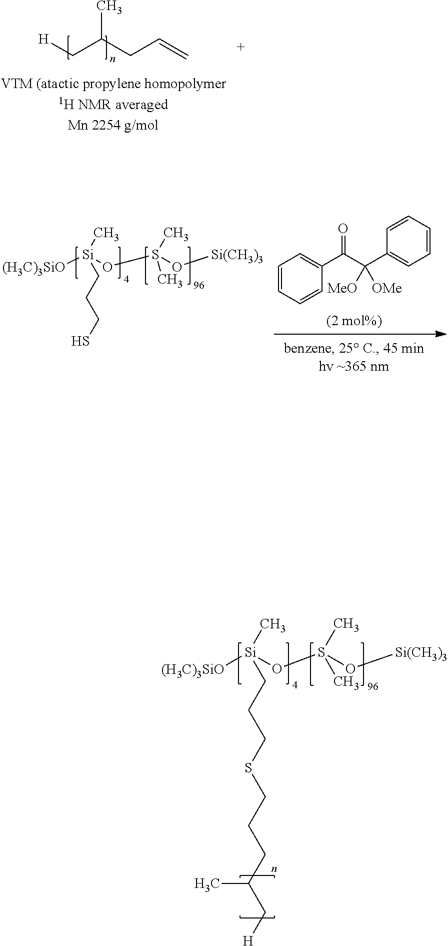

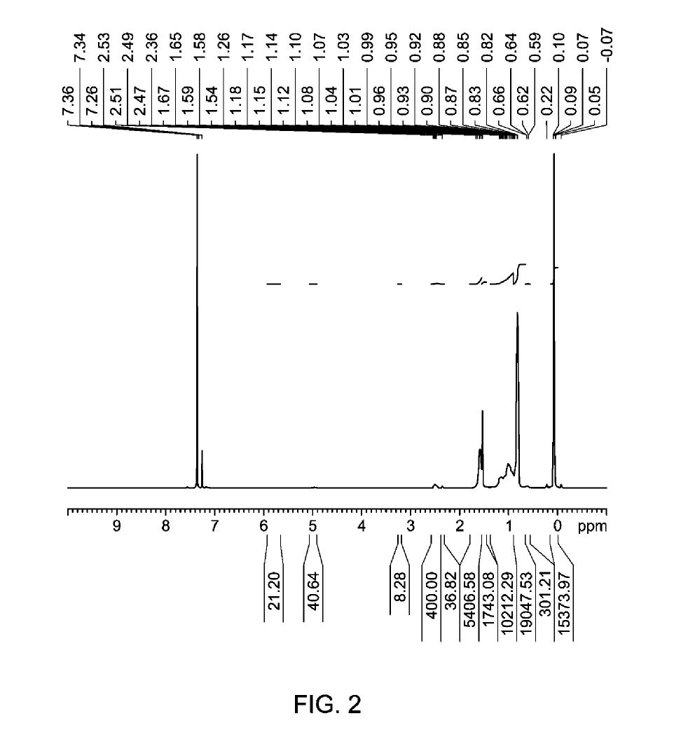

A mixture of vinyl-terminated atactic propylene homopolymer (¹H NMR Mn 2254.20 g/mol, 4.9491 g, 2.1955 mmol), (3-mercaptopropyl methylsiloxane)-dimethylsiloxane copolymer (4.00 g, 0.5489 mmol of thiol group/gram of polymer), 2,2-dimethoxy-2-phenylacetophenone (0.0113 g, 0.0441 mmol) and anhydrous benzene (3 ml) was magnetically stirred at room temperature (20° C.). The inhomogeneous mixture was irradiated with a 4 W UV lamp at 365 nm for 50 minutes at room temperature (20° C.). The mixture turned to a homogeneous solution after approximately 5 minutes of UV irradiation. After a reaction time of 5 minutes, an aliquot of the reaction mixture was analyzed by ¹H NMR (CDCl₃, 400 MHz), which showed the 80% conversion of vinyl group to the corresponding thioether (polysiloxane-(CH₂)₃—S—(CH₂)₃—PP) functionality (δ 2.46-2.53 ppm, 4 Hs, CH₂—S—CH₂) in FIG. 2. The only impurities in the crude products are benzene (reaction solvent) and trace of toluene (from VT aPP). The colorless solution was diluted with CH₂Cl₂ (10 ml), concentrated on a rotary evaporator, and dried under vacuum to give the aPP-functionalized polysiloxane material as a colorless viscous oil.

The reaction conditions used to react the vinyl double bond in VTM with the thiol group in polysiloxane is a radical initiator. A radical initiator is used at a low mol % (an amount of 2 mol % was used in Examples 1 and 2, but the amount can be within a range from 0.01 or 0.02 or 0.08 or 0.1 or 0.5 mol % to 0.05 or 0.08 or 0.10 or 0.50 or 1.0 or 1.5 or 2.0 or 3.0 mol %) relative to the VTM. In Examples 1 and 2, 2, 2-dimethoxy-2-phenylacetophenone was used as a radical initiator, although others are appropriate, which can react under ultraviolet light irradiation (photochemical conditions) to generate radicals. The free radicals can then initiate the addition of thiol group in polysiloxane to the double bond in VTM. In addition to using photochemical conditions, one may also use heat (i.e., thermal conditions) to generate free radicals from different type of radical initiators such as AIBN (Azobisisobutyronitrile) or similar azo compounds.

### Example 3. Synthesis of PMHS-sb-aPP

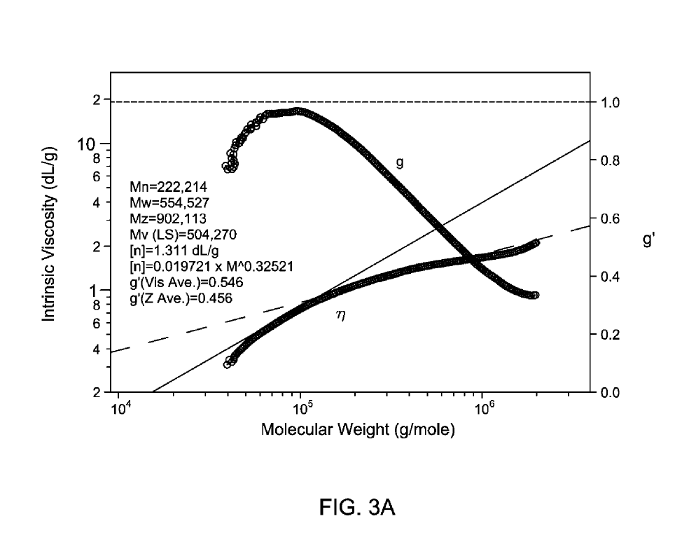

A vinyl terminated atactic propylene homopolymer aPP-A (GPC-DRI: Mn=45.9 Kg/mol, Mw=95.0 Kg/mol; GPC-MALLS: Mn=51.2 Kg/mol, Mw=89.9 Kg/mol, g′=1.0) was prepared by metallocene coordinated polymerization as described in the previous patent application of WO2009/155471. aPP-A (25.4 g) was dissolved in toluene (150 ml) and dried over 3 A sieves for at least 48 hrs. The solution was decanted away from the sieves, the sieves washed with additional toluene and the combined toluene solutions transferred to a glass vessel with a Teflon stir bar. Polymethylhydrosiloxane, PMHS (Aldrich, 2 Kg/mol, 0.120 g) was added to the reaction mixture and the mixture was sparged with dry air. Kardstedts catalyst (70 mg) was added and the reaction mixture was stirred at ambient temperature for 12 hrs while maintaining a constant dry air sparge. Octene (20 mls) was added and the reaction was stirred an additional 48 hrs. All volatiles were removed and the rubber-like product dried in a vacuum oven at 100° C. for 12 hrs. As shown in FIGS. 3A and 3B, using the number average molecular weight measured, the number average arm number is 4. Additionally, the low g′ value reflects the comb branch nature of the final product.

More particularly, with reference to FIGS. 3A and 3B, the red strait line upper left is the log/log plot of the intrinsic viscosity of a standard (polystyrene, from intrinsic viscosity measurements) vs the MW (from DRI detection of the standard) with the coefficient, “a” from polypropylene (0.705). It's the Mark-Houwink plot of universal calibration; viscosity=KM^{a}. The blue curve is the actual log/log plot of the inventive VTM-modified PMHS. The “dip”, especially at higher MW's, shows that the actual/measured viscosity is lower than predicted from a linear molecule and is indicative of long chain branching. The branching is higher at higher MWs for these inventive polymers. The green curve is just the ratio of the blue/red (actual viscosity/linear viscosity) over the MW range. g′ is the average. The lower g′ is the more branching it is considered to have.

### Comparative Comb-Star Polymer Example.

Commercial multi-arm star copolymer SV300, a star copolymer viscosity modifier from Infineum, is used as is as the reference. SV300 contains 6% by weight of crosslinked polystyrene star core with 30 arms of hydrogenated polyisoprene, or poly(alternated ethylene-propylene), with overall molecular weight of 875,000. Its hydrodynamic radius in PAO4 (4 centistoke viscosity poly(alpha olefin), ExxonMobil Chemical) is 25 nm. It can provide good thickening in lubricant basestock and deliver early shear thinning onset. However, its coil contracts with temperature and it has poor shear stability and thermo-oxidative stability.

PAO4 is the polyalphaolefin of 4 cps (centapoise) viscosity. PAO4 is a trimer of decene. Other basestocks may be used, including Jurong 150, a group II base stock, or EHC-50, made by ExxonMobil. Group II basestock is a hydrocarbon fluid that has been hydrogenated (Group I is not hydrogenated, or hydro-processed). Group II basestock consists of various hydrocarbon components and is “crude source” dependent. Group II is defined based on the viscosity index (VI) value. When VI is within a range of 80 to 120, it is called Group II for hydrotreated stocks.

Coil Expansion with Temperature Experiment 1.

0.5 wt % each of the product in Example 3 and the comparative comb-star polymer were separately dissolved in PAO4. The shear viscosity of the dilute polymer solutions was measured using a double gap Couette flow cell on a stress-controlled MCR501 rheometer from Anton-Paar. The solution sample was loaded at room temperature (20° C.) and the flow cell was set at −30° C. and the temperature was ramped from −30 to 150° C. with 10° C. increments. At each temperature, the solution shear viscosity was measured for shear rates ranging from 1 to 2,000 l/s. The intrinsic viscosity was extrapolated to zero concentration by using the Huggins equation. Prior to dynamic light scattering measurements, vigorous filtrations to remove contaminants are necessary. Dynamic light scattering measurements were conducted using a Wyatt Dawn Heleos II instrument equipped with a flow cell that has an antireflective coating operated from 0 to 140° C. with <1% baseline fluctuations.

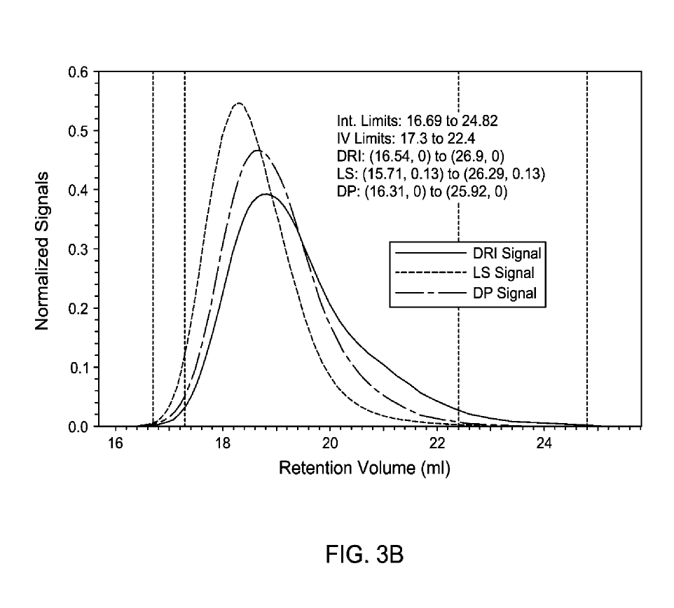

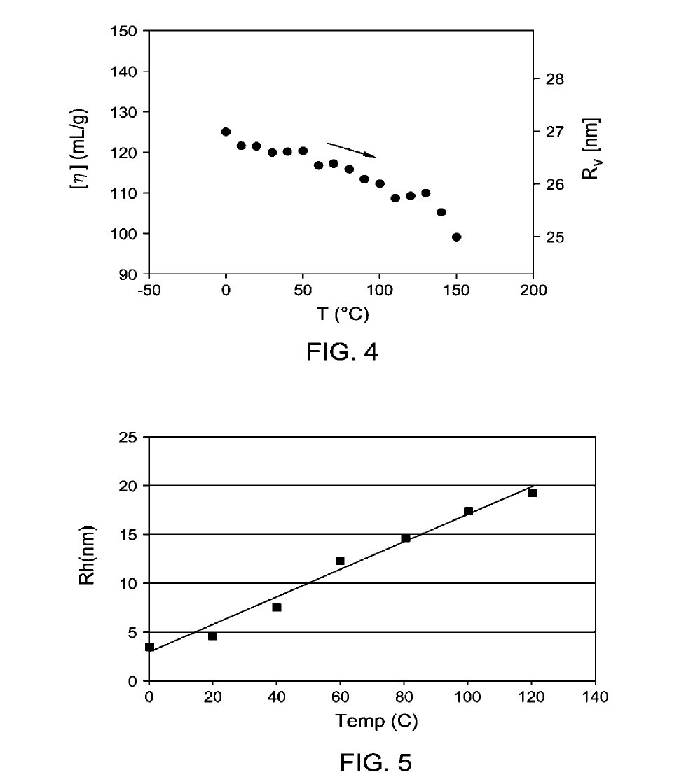

As shown in FIG. 4, the intrinsic viscosity and the corresponding viscometric radii of the comparative SV300 decrease with increasing temperature. This coil contraction with temperature is not desirable since it would have a negative impact on viscosity index and on temperature coefficient. As shown in FIG. 5, the hydrodynamic radii of the inventive comb-star polymer of Example 3 as measured by dynamic light scattering increases with temperature. This coil expansion with temperature is a desirable feature for viscosity modifiers and is a result of geminal substituted backbone in Example 3.

### Viscosity Modifier Performance Experiment 2.

1% each of SV300 and Example 3 were each dissolved in Jurong 150 base stock (ExxonMobil) and the resulting solutions were evaluated for their viscometric performance. Their evaluation results are listed in Table 1. As shown in FIGS. 4 and 5, Example 3 inventive comb-star polymer has smaller coil dimensions and, hence, delivers less thickening as that of SV300. Considering the fact that VI depends on thickening as a result of the VI calculation method, Example 3 can provide equal VI as that of SV300 despite its lower thickening efficiency. This can be attributed to the coil expansion characteristics of inventive Example 3. Although the MW of Example 3 is ¼ to that of SV300 comparative comb-star polymer, the viscometric performance of a lubricant product using Example 3 comb-star polymer is comparable to that with the commercial SV300 comb-star as the viscosity modifier. Kinematic viscosity measurement as per ASTM D445.

TABLE 1
Viscometric performance of SV300 and
Example 3 in Jurong 150 base stock.

| | | PMHS-sb-aPP |
|---|---|---|
| Parameter | SV300 | (Example 3) |
| KV40 | 92 | 67.37 |
| KV100 | 14.51 | 11.24 |
| Viscosity Index (VI) | 164 | 160 |
| Thickening | 2.9 | 2.14 |
| Oxidation (° C.) | 199.8 | 208 |
| HTHS (high temp/high shear) | 3.23 | 2.94 |

Now, having described the inventive comb-star poly(siloxane-polyolefin), methods of making it, and its use as a viscosity modifier, described herein in numbered paragraphs are:

1. A comb-star poly(siloxane-polyolefin) comprising the reaction product of at least a vinyl-terminated macromer and a functional-poly(dialkylsiloxanes) comprising functional groups comprising (or consisting of) compounds of the formula:

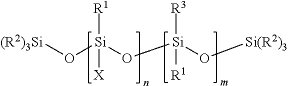

wherein n and m are integers from 2 or 3 or 5 to 50 or 80 or 100 or 200; each of R¹, R² and R³ are independently selected from C₁ to C₁₀ or C₂₀ alkyls, especially methyl, ethyl or propyl groups; and wherein X is the functional group capable of facilitating the formation of a bond between the vinyl group of the vinyl-terminated macromer and a silicon atom, most preferably, X is hydride or a mercaptan such as methyl, ethyl, propyl or butyl mercaptans; and
wherein the comb-star poly(siloxane-polyolefin) has the following features:
a g′_{(vis avg)} of less than 0.80 or 0.70 or 0.60 or 0.50;
a comb number of greater than 2 or 3 or 4 to 30 or 40 or 50 or 100; and
a number average molecular weight (Mn) within the range of from 25,000 or 50,000 or 75,000 or 100,000 g/mole to 300,000 or 350,000 or 400,000 or 500,000 g/mole.
2. A comb-star comb-star poly(siloxane-polyolefin), wherein the poly(siloxane-polyolefin) is a mixture of polymers having the general structure:

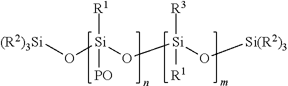

wherein “PO” is the vinyl-terminated macromer portion of the reaction product; each R¹, R² and R³ is independently selected from C₁ to C₁₀ or C₂₀ alkyls; and n (the “comb number”) and m are integers from 3 or 5 to 50 or 80 or 100 or 200.
   3. The comb-star poly(siloxane-polyolefin) of paragraph 2, wherein the ratio of m/n is greater than 1 or 2 or 3 or 4; or preferably, wherein m/n is within a range of from 2 or 3 or 4 to 7 or 9 or 10 or 12.
   4. The comb-star poly(siloxane-polyolefin) of paragraphs 1 or 2, wherein the functional-poly(dialkylsiloxane) comprises at least one functional group “X” of the “—O—SiX(R)—O—” selected from the group consisting of hydride, alkylene, alkyl mercaptans, alkylamines, siloxanes, and combinations thereof; preferably hydride; and where the “R” is selected from C₁ to C₁₀ or C₂₀ alkyls.
   5. The comb-star comb-star poly(siloxane-polyolefin) of paragraph 4, wherein X is hydride or an alkyl mercaptan, preferably a methyl, ethyl, propyl or butyl mercaptans.
   6. The comb-star poly(siloxane-polyolefin) of any one of the previous numbered paragraphs, wherein the residual functional groups on the silicon atoms, preferably silanes, is less than 1 mole %, preferably less than 0.5 mole %, most preferably less than 0.1 mole % relative to the original functional-poly(dialkylsiloxanes).
   7. The comb-star poly(siloxane-polyolefin) of any one of the previous numbered paragraphs, wherein the number average molecular weight (Mn) of the functional-poly(dialkylsiloxane) is within the range from 500 or 700 or 1000 g/mole to 4000 or 4400 or 4600 or 5000 or 25,000 or 50,000 g/mole.
   8. The comb-star poly(siloxane-polyolefin) of any one of the previous numbered paragraphs, wherein the comb-star poly(siloxane-polyolefin) has a g′_{(z avg)} of less than 0.70 or 0.60 or 0.50.
   9. The comb-star poly(siloxane-polyolefin) of any one of the previous numbered paragraphs, wherein the comb-star poly(siloxane-polyolefin) has a weight average molecular weight (Mw) to number average molecular weight (Mn) ratio (Mw/Mn) within the range from 2.0 or 2.5 to 5.0 or 6.0.
   10. The comb-star poly(siloxane-polyolefin) of any one of the previous numbered paragraphs, wherein the comb-star poly(siloxane-polyolefin) is additionally the reaction product of a C₂ to C₁₀ or C₂₀ alkene.
   11. The comb-star poly(siloxane-polyolefin) of any one of the previous numbered paragraphs, wherein the glass transition temperature (Tg) of the vinyl-terminated macromer is preferably less than 0° C., more preferably less than −10° C., and most preferably less than −20° C.
   12. A viscosity modified base stock comprising the poly(siloxane-polyolefin) any one of the previous numbered paragraphs and a lubricant base stock of Group I, Group II, Group III, Group IV, and Group V.
   13. The viscosity modified base stock of paragraph 12, wherein the poly(siloxane-polyolefin) is present in the base stock at a level within the range of from 0.05 or 0.10 or 0.40 wt % to 0.60 or 0.80 wt % or 1.0 or 5 wt % of the combination of base stock and poly(siloxane-polyolefin).
   14. The viscosity modified base stock of paragraph 13, wherein as the temperature of the modified base stock increases, the hydrodynamic radius of the poly(siloxane-polyolefin) increases; wherein the radius increases by at least 2 or 4 or 6 or 8 nm for every 80 or 100° C. or more increase in temperature.

The invention also includes the use of the comb-star poly(siloxane-polyolefin) of any one of the previously numbered embodiments as a viscosity modifier in base stock.

The invention also includes the use of a vinyl-terminated macromer and functional-poly(dialkylsiloxanes) as reactants in a chemical reaction to form a viscosity modifier, or comb-star poly(siloxane-polyolefin).

1. A comb-star poly(siloxane-polyolefin) comprising the reaction product of at least vinyl-terminated macromer and functional-poly(dialkylsiloxanes) comprising compounds of the following formula: 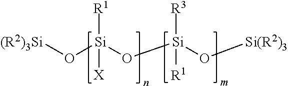
wherein n and m are integers from 2 to 200; each of R¹, R² and R³ are independently selected from C₁ to C₂₀ alkyls; and X is a functional group capable of facilitating the formation of a bond between the vinyl group of the vinyl-terminated macromer and a silicon atom; and
wherein the comb-star poly(siloxane-polyolefin) has the following features:
a g′_{(vis avg)} of less than 0.80;
a comb number of 2 or more; and
a number average molecular weight (Mn) within the range of from 25,000 g/mole to 500,000 g/mole.

2. A comb-star poly(siloxane-polyolefin), wherein the poly(siloxane-polyolefin) is a mixture of polymers having the general structure: 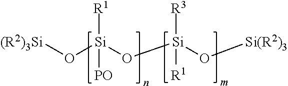
wherein “PO” is the vinyl-terminated macromer portion of the reaction product; each R¹, R² and R³ is independently selected from C₁ to C₂₀ alkyls; and n and m are integers from 2 to 200.

3. The comb-star poly(siloxane-polyolefin) of claim 1, wherein n is within the range from 2 to 10.

4. The comb-star poly(siloxane-polyolefin) of claim 3, wherein X is hydride or a mercaptan selected from the group consisting of methyl, ethyl, propyl and butyl mercaptans.

5. The comb-star poly(siloxane-polyolefin) of claim 1, wherein the residual functional groups on the silicon atoms, preferably silanes, is less than 1 mole %, preferably less than 0.5 mole %, most preferably less than 0.1 mole % relative to the original functional-poly(dialkylsiloxanes).

6. The comb-star poly(siloxane-polyolefin) of claim 1, wherein the number average molecular weight (Mn) of the functional-poly(dialkylsiloxane) is within the range from 500 g/mole to 50,000 g/mole.

7. The comb-star poly(siloxane-polyolefin) of claim 1, wherein the comb-star poly(siloxane-polyolefin) has a g′_{(z avg)} of less than 0.70.

8. The comb-star poly(siloxane-polyolefin) of claim 1, wherein the comb-star poly(siloxane-polyolefin) has a weight average molecular weight (Mw) to number average molecular weight (Mn) ratio (Mw/Mn) within the range from 2.0 to 6.0.

9. The comb-star poly(siloxane-polyolefin) of claim 1, wherein the comb-star poly(siloxane-polyolefin) is additionally the reaction product of a C₂ to C₂₀ alkene.

10. The comb-star poly(siloxane-polyolefin) of claim 1, wherein the glass transition temperature (Tg) of the vinyl-terminated macromer is preferably less than 0° C.

11. The comb-star poly(siloxane-polyolefin) of claim 1, wherein the comb-star poly(siloxane-polyolefin) is a mixture of polymers having the general structure: 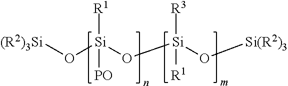
wherein “PO” is the vinyl-terminated macromer portion of the reaction product; each R¹, R² and R³ is independently selected from C₁ to C₂₀ alkyls; and n and m are integers from 2 to 200.

12. The comb-star poly(siloxane-polyolefin) of claim 11, wherein the ratio of m/n is greater than 1; or preferably, wherein m/n is within a range of from 2 to 12.

13. A viscosity modified base stock comprising the poly(siloxane-polyolefin) of claim 1 and a lubricant base stock of Group I, Group II, Group III, Group IV, and Group V.

14. The viscosity modified base stock of claim 13, wherein the poly(siloxane-polyolefin) is present in the base stock at a level within the range of from 0.05 wt % to 5 wt % of the combination of base stock and poly(siloxane-polyolefin).

15. The viscosity modified base stock of claim 14, wherein as the temperature of the modified base stock increases, the hydrodynamic radius of the poly(siloxane-polyolefin) increases; wherein the radius increases by at least 2 nm for every 80° C. or more increase in temperature.

16. The comb-star poly(siloxane-polyolefin) of claim 2, wherein the number average molecular weight (Mn) of the functional-poly(dialkylsiloxane) is within the range from 500 g/mole to 50,000 g/mole.

17. The comb-star poly(siloxane-polyolefin) of claim 2, wherein the comb-star poly(siloxane-polyolefin) has a g′_{(z avg)} of less than 0.70.

18. The comb-star poly(siloxane-polyolefin) of claim 2, wherein the comb-star poly(siloxane-polyolefin) has a weight average molecular weight (Mw) to number average molecular weight (Mn) ratio (Mw/Mn) within the range from 2.0 to 6.0.

19. The comb-star poly(siloxane-polyolefin) of claim 2, wherein the comb-star poly(siloxane-polyolefin) is additionally the reaction product of a C₂ to C₂₀ alkene.

20. The comb-star poly(siloxane-polyolefin) of claim 2, wherein the glass transition temperature (Tg) of the vinyl-terminated macromer is preferably less than 0° C.

21. The comb-star poly(siloxane-polyolefin) of claim 2, wherein n is within the range from 2 to 10.
